(19) United States
(12) Patent Application Publication
(10) Pub. No.: US 2006/0008713 A1
(43) Pub. Date: Jan. 12, 2006

(54) Color filter and method for manufacturing the same, electro-optical device, and electronic apparatus

(75) Inventor: Naoyuki Toyoda, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/127,127

(22) Filed: May 12, 2005

(30) Foreign Application Priority Data
Jul. 7, 2004 (JP) 2004-200556

(51) Int. Cl. G02B 5/20; G02F 1/1335

(52) U.S. Cl. 430/7; 347/106; 349/106

(57) ABSTRACT

A method for manufacturing a color filter, the color filter having a plurality of pixels surrounded by partition walls on a substrate, including: forming the partition wall having a liquid repellence on the substrate; forming a lyophilic layer by ejecting a lyophilic liquid droplet which develops a lyophilic characteristic in the pixel; and coating a coloring droplet over the pixel on which the lyophilic layer has been formed.

### BACKGROUND OF THE INVENTION

1. Technical Field

The present invention relates to a color filter and a method for manufacturing the same, an electro-optical device, and an electronic apparatus.

2. Related Art

To manufacture a color filter by a liquid droplet ejection method (ink-jet method), a pigment droplet (ink) is coated successively on each pixel which is surrounded by partition walls called banks. However, unevenness may occur if the droplet does not diffuse evenly inside the pixel, and color mixture may occur if the ink flows over the partition walls. Therefore, the partition walls need to be liquid repellent, and the inside pixel needs to be highly lyophilic.

Conventionally, there are techniques in which the partition walls are formed using a liquid repellent photoresist; a plasma treatment is conducted using oxygen and fluorine-containing gas so that the partition walls acquire liquid repellence higher than that of the inside pixel as described in a first example; and lyophilic/liquid repellent patterning is carried out using a photocatalyst and a fluoric silicon material as described in a second example.

Japanese Unexamined Patent Publication No. 2002-372921 is the first example of related art.

Japanese Unexamined Patent Publication No. 2000-227513 is the second example of related art.

However, these conventional techniques have some problems.

That is, because the liquid repellence of the partition walls must at least be maintained in order to avoid color mixture, it is difficult for the inside pixel to acquire high diffusiveness in its entirety, particularly near the partition walls, for example. Therefore, a flat and evenly thick color layer cannot be obtained, and the display quality may possibly be impaired.

Particularly, in recent years, it has been an environmental concern to use the plasma treatment. If the plasma treatment is to be avoided, the partition walls are formed using a liquid repellent photoresist, and the inside pixel is not lyophilized. This makes it inevitable to rely on a substrate such as a glass substrate for its own innate lyophilic characteristic, and it is similarly difficult to acquire sufficient diffusiveness.

### SUMMARY

An advantage of the invention is to provide a color filter and a method for manufacturing the same, an electro-optical device, and an electronic apparatus.

According to an aspect of the invention, a method for manufacturing a color filter includes: the color filter having a plurality of pixels surrounded by partition walls on a substrate; forming the partition wall having liquid repellence on the substrate; forming a lyophilic layer by ejecting a lyophilic liquid droplet which develops a lyophilic characteristic in the pixel; and coating a coloring droplet over the pixel on which the lyophilic layer has been formed.

Therefore, in the method for manufacturing the color filter of the invention, it is possible to obtain a flat and evenly thick color layer even when the pixel is not lyophilized such as by plasma treatment, because the coloring droplet coated on the substrate diffuses along the lyophilic layer. Further, in the invention, because the lyophilic layer is formed by ejecting a lyophilic liquid droplet, it consumes a minimum amount of droplets compared to when the droplet is coated over the entire substrate surface such as by spin coating; therefore, the lyophilic liquid can be used efficiently. Furthermore, in the invention, it is possible to coat the coloring droplet and the lyophilic liquid droplet using the same device and following the same process, which can contribute to higher productivity.

To coat the coloring droplet, a suitably employable procedure is such that the coloring droplet is coated after the lyophilic liquid droplet is ejected onto the plurality of pixels or that the coloring droplet is coated on the pixel every time the lyophilic liquid droplet is ejected onto each pixel.

As the lyophilic liquid, it is suitable to employ a composition containing a fine particle consisting at least one substance selected from titanium oxide (TiO₂), zinc oxide (ZnO), tin oxide (SnO₂), strontium titanate (SrTiO₃), tungsten oxide (WO₃), bismuth oxide (Bi₂O₃), and ion oxide (Fe₂O₃). Further, an aqueous dispersion of silica (SiO₂) may also be employed.

When a composition containing titanium oxide is used as the lyophilic liquid, for example, it is also suitable to develop the lyophilic characteristic in the lyophilic layer by conducting the plasma treatment to the substrate or by adding lyophilic silica to the lyophilic layer. If the lyophilic titanium oxide with the addition of lyophilic silica is used, it is not necessary to add such process as the plasma treatment or an ultraviolet exposure, and, therefore, it is possible to increase productivity.

Further, it is preferable that an average diameter of the fine particle contained in the lyophilic liquid be 1.0 μm or less.

In addition, in the invention, if a composition containing titanium oxide is used as the lyophilic liquid, it is preferable to include providing an ultraviolet filter on the substrate.

By doing so, it becomes possible to suppress ultraviolet irradiation to the titanium oxide and to prevent the coloring agent from being negatively affected by a photocatalystic effect of the titanium oxide.

Further, according to another aspect of the invention, because the color filter of the invention is manufactured by the above-referenced manufacturing method, it is possible to obtain the color filter with pixels having the flat and evenly thick color layers formed thereon.

Also, according to a still further aspect of the invention, an electro-optical device of the invention includes the color filter. According to a yet another aspect of the invention, an electronic apparatus of the invention includes the electro-optical device.

Therefore, it is possible with the invention to easily and precisely form the flat and evenly thick color layer and to obtain the electro-optical device and the electronic apparatus with which high-precision and minute patterning is possible and which has high-quality display characteristics.

### BRIEF DESCRIPTION OF THE DRAWINGS

The invention will be described with reference to the accompanying drawings, wherein like numbers refer to like elements and wherein:

FIG. 1 is a diagram showing an example of an active matrix liquid-crystal device (liquid-crystal display device).

FIG. 2 is a cross-sectional diagram showing a composition of the active matrix liquid-crystal device.

FIG. 3 is a pattern diagram showing an example of an ink-jet device.

FIG. 4 is a diagram of an ink-jet head shown from the side of the nozzle surface.

FIG. 5 is a diagram to explain principals of liquid material ejection by a piezo-type ink-jet method.

FIG. 6 is a pattern diagram showing a method for manufacturing the liquid-crystal device.

FIG. 7 is a pattern diagram showing the method for manufacturing the liquid-crystal device.

FIG. 8 is a diagram to explain diffusion of a droplet landed in a filter element formation region.

FIG. 9 is a pattern diagram showing a method for manufacturing the color filter according to a second embodiment.

FIG. 10 is a diagram showing an example of the electronic apparatus of the invention.

### DESCRIPTION OF THE EMBODIMENTS

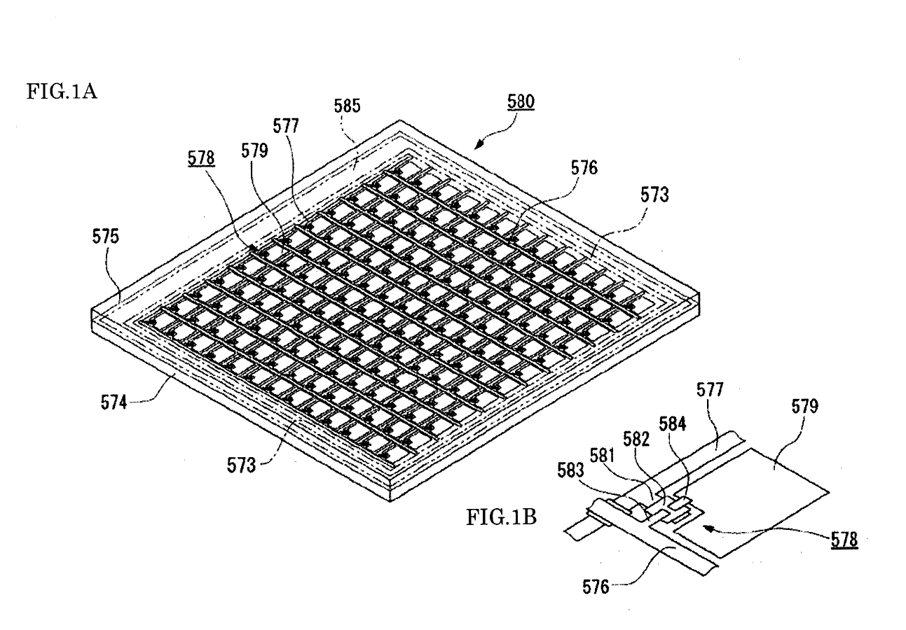

Now, embodiments of the color filter and the method for manufacturing thereof, the electro-optical device and the electronic apparatus of the invention will be described with reference to FIGS. 1 through 10.

First, a liquid-crystal device (electro-optical device) having the color filter of the invention will be described.

Here, an active matrix liquid-crystal device is described as an example.

FIG. 1 shows the example of the active matrix liquid-crystal device (liquid-crystal display device) using a thin film transistor (TFT) as a switching element. FIG. 1A is a perspective view of an entire composition of the liquid display device of this example. FIG. 1B is an enlarged diagram of one pixel of FIG. 1A.

In FIG. 1, in a liquid-crystal device (electro-optical device) 580 of this working example, an element substrate 574, on which a TFT element is formed, is arranged so as to face an opposing substrate 575. Between the substrates 574 and 575, a sealing material 573 is placed in a form of a frame. In a region surrounded by the sealing material 573 placed between the substrates, a liquid-crystal layer (not shown) is encapsulated.

On a liquid-crystal surface of the element substrate 574, a plurality of source lines 576 (data lines) and a plurality of gate lines 577 (scanning lines) are arranged in matrix, each intersecting with one another. Near an intersection of each source line 576 and gate line 577, a TFT element 578 is formed, and pixel electrodes 579 are coupled via each TFT element 578. The plurality of pixel electrodes 579 are arranged in matrix in plan view. In contrast, on the surface of the liquid-crystal layer of the opposing substrate 575, a common electrode 585 made of a transparent conductive material composed of indium tin oxide (ITO) and the like is formed corresponding to the display region.

As shown in FIG. 1B, the TFT element 578 includes: a gate electrode 581 extending from the gate line 577, an insulating film (not shown) covering the gate electrode 581, a semiconductor layer 582 formed on the insulating film, a source electrode 583 coupled with the source line 576 extending from the source region inside the semiconductor layer 582, and a drain electrode 584 coupled with the drain region inside the semiconductor layer 582. Further, the drain electrode 584 of the TFT element 578 is coupled with the pixel electrode 579.

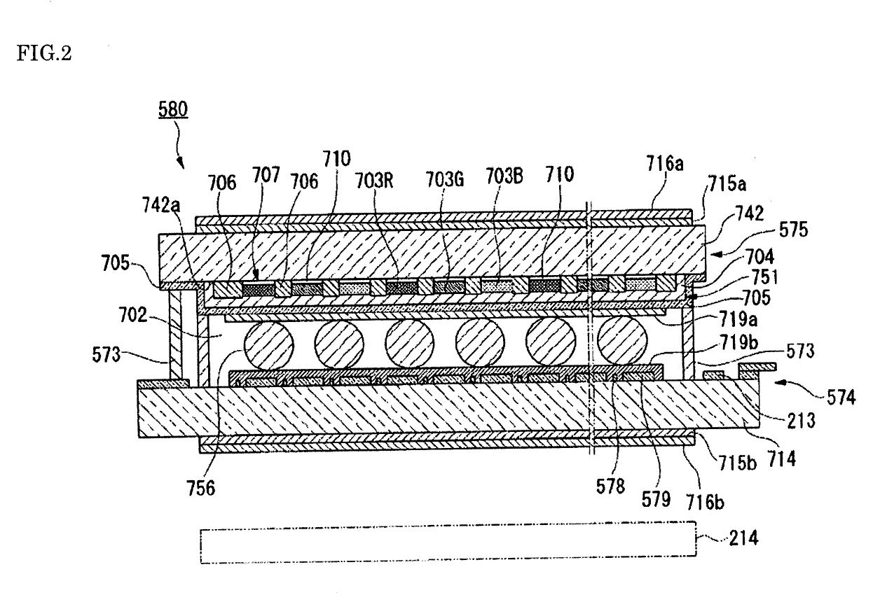

FIG. 2 is a cross-sectional diagram showing a composition of the active matrix liquid-crystal device.

The liquid-crystal device 580 is composed mainly of a liquid-crystal panel provided with: the element substrate 574 and the opposing substrate 575 arranged to oppose each other, a liquid-crystal layer 702 sandwiched therebetween, a retardation film 715a attached to the opposing substrate 575, a polarizing film 716a, a retardation film 715b attached to the element substrate 574, and a polarizing film 716b.

Further, the element substrate 574 is provided with a driver IC 213 for supplying a drive signal to the liquid-crystal layer 702 and with a backlight 214 as a light source for a transmissive display is provided on the outside of the polarizing film 716b.

By mounting attaching elements such as wires for transmitting electric signals and support mediums, the liquid-crystal device is composed as a final product.

The opposing substrate 575 is composed mainly of a light transmitting substrate 742 such as quartz or glass and of a color filter 751 formed on this substrate 742. The color filter 751 is composed of a partition wall 706 consisting of a black matrix, a bank, and the like; color layers 703R, 703G, and 703B as filter elements; a lyophilic layer 710 inserted between the substrate 742 and the color layers 703R, 703G, and 703B; and a protection film 704 covering the partition wall 706 and the color layers 703R, 703G, and 703B.

The partition walls 706 are formed on one surface 742a of the substrate 742, arranged in matrix and so as to surround each filter element formation region (pixel) 707 which is the region for forming the color layers 703R, 703G, and 703B.

Further, the partition wall 706 is composed, for example, of a black-colored photosensitive resin film. The black-colored photosensitive resin film at least includes, for example, a positive-type or a negative-type photosensitive resin used for a common photoresist and a black inorganic or organic pigment such as carbon black. In this working example, a material having liquid repellence such as fluoric resin is used as the partition wall 706. Also, because this partition wall 706 includes a black inorganic or organic pigment and is formed in an area outside the region for forming the color layers 703R, 703G, and 703B, it also acts as a shield that can block light transmission between the color layers 703R, 703G, and 703B.

The lyophilic layer 710 is formed by coating a lyophilic transparent substance, more specifically, an aqueous dispersion (lyophilic liquid) of lyophilic titanium oxide, or the like, which is dispersed in a dispersion medium such as alcohol or water. The morphology of the titanium oxide crystal to be used may have an anatase structure or a brookite structure. Further, this titanium oxide has the addition of a lyophilic material such as silica and has a characteristic of maintaining the lyophilic property without the plasma treatment or the like.

The color layers 703R, 703G, and 703B are formed by introducing, that is, ejecting each of the filter element materials (coloring materials), red (R), green (G), and blue (B), to the filter element formation region 707 which stretches from the inner wall of the partition wall 706 to the substrate 742 by use of the ink-jet method (liquid ejection method) and by being dried thereafter. The material of the filter element can be composed of, for example, a thermosetting acrylic resin, an organic pigment, a solvent of, for example, a derivative of diethyleneglycol buthylether, and the like.

In addition, an electrode layer 705 for driving the liquid crystal which is composed of the transparent conductive material such as indium tin oxide (ITO) is formed on almost an entire surface of the protection film 704. Further, an alignment film 719a is provided covering this liquid-crystal-driving electrode layer 705. Also, an alignment film 719b is provided on the pixel electrode 579 on the side of the element substrate 574.

On the element substrate 574, an insulating layer (not shown) is formed on a light-transmitting substrate 714 such as quarts or glass. Further, on this insulating layer, the TFT element 578 and the pixel electrode 597 are formed. Also, as shown in the preceding FIG. 1, the plurality of scanning lines and the plurality of signal lines are formed in matrix on the insulating film formed on the substrate 714. The pixel electrode 579 is provided in each region surrounded by the scanning line and the signal line, and the TFT element 578 is incorporated at a position where each pixel electrode 579, scanning line, and signal line are electrically coupled. By applying signals to the scanning line and signal line, the TFT element 578 is turned on and off, and the energizing control of the pixel electrode 579 is thereby conducted. Furthermore, in this working example, the electrode layer 705 formed on the opposing substrate 575 is a whole surface electrode covering the entire pixel region. Additionally, the wiring circuit of the TFT and the pixel electrode can be configured in various ways.

The element substrate 574 and the opposing substrate 575 are laminated, having a certain gap therebetween, by a sealing material 573 formed along the peripheral of the opposing substrate 575. Further, a reference numeral 756 is a spacer to maintain the gap (cell gap) between both substrates at the substrate surfaces. Between the element substrate 574 and the opposing substrate 575, a rectangular liquid-crystal-encapsulating region is formed into zones by the frame-shaped sealing material (a plan view thereof being omitted). Liquid crystal is encapsulated in this liquid-crystal-encapsulating region.

Next, an ink-jet device used when manufacturing the above-referenced color filter 751 will be described.

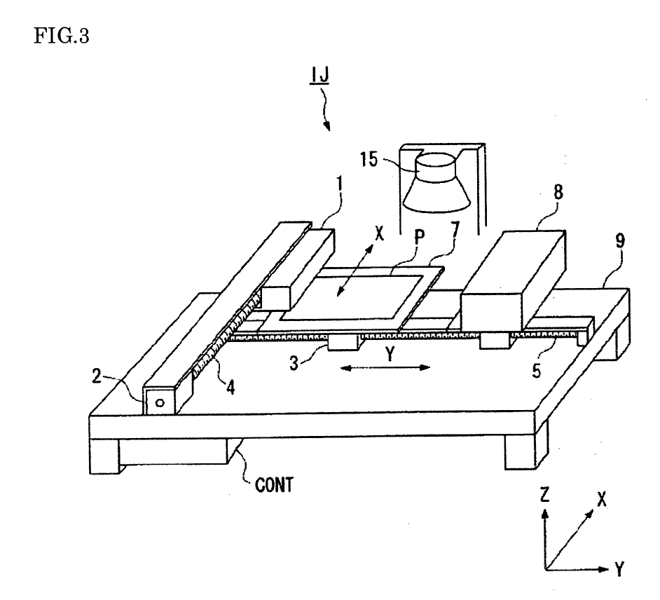

FIG. 3 is a pattern diagram showing a rough structure of an ink-jet device IJ.

The ink-jet device IJ is provided with: an ink-jet head 1, an X-direction drive axis 4, a Y-direction guide axis 5, a control device CONT, a stage 7, a cleaning unit 8, a base 9, and a heater 15.

The stage 7 supports a substrate P, on which ink (liquid material) is supplied by the ink-jet device IJ, and has a stabilizing unit (not shown) to stabilize the substrate P at a reference position.

The ink-jet head 1 is a multiple-nozzle type ink-jet head having a plurality of jet nozzles and matches the direction of the length with the Y direction. The plurality of ink-jet nozzles are evenly spaced and lined along the Y direction on the bottom surface of the ink-jet head 1. The jet nozzle of the ink-jet head 1 ejects ink containing the above-referenced coloring materials to the substrate P which is supported by the stage 7.

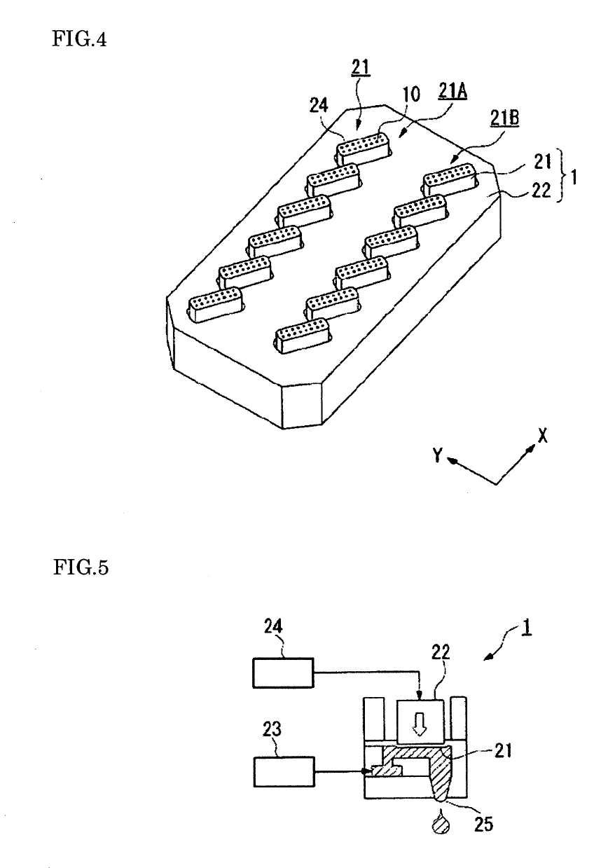

FIG. 4 is a diagram of an ink-jet head 1 shown from the side of the nozzle surface (the side opposing the substrate P). As shown in FIG. 4, the ink-jet head 1 includes a plurality of head parts 21 and a carriage part 22 that mounts these head parts 21 thereon. A nozzle surface 24 of the head part 21 is provided with a plurality of jet nozzles 10 that eject droplets of the liquid material. Each head part 21 (the nozzle surface 24) is rectangular in plan view. The plurality of jet nozzles 10 are evenly spaced and lined in rows along an approximate Y direction which is the length of the head part 21. The jet nozzles 10 are also lined on each nozzle surface 24 in two rows (e.g., 180 nozzles per row, 360 nozzles in total) in an approximate X direction which is the width of the head part 21. Further, the head part 21 has the jet nozzles 10 to face a substrate 101. The plurality of head parts 21 are positioned and supported by the carriage part 22, lined in rows along an approximate Y direction while being tilted a given degree to the Y axis, and evenly spaced and arranged in two rows (in FIG. 4, 6 head parts per row, 12 in total) in the X direction.

Additionally, the ink-jet head 1 includes an angle adjuster (not shown) which can adjust an installation angle of the ink-jet head 1 to the Y direction. By this angle adjuster, the ink-jet head 1 has a changeable angle θ to the Y direction. The angle adjuster can arrange the jet nozzles 10 along the Y direction, adjust the angle of the jet nozzle 10 to the Y direction, and adjust a pitch between the nozzles. Further, the gap between the substrate P and the nozzle surface may be adjusted so as to keep a predetermined distance.

Referring again to FIG. 3, an X-direction drive motor 2 is connected to the X-direction drive axis 4. The X-direction drive motor 2 is a stepping motor, for example, and makes the X-direction drive axis 4 revolve upon receiving a drive signal for the X direction from the control device CONT. When the X-direction drive axis 4 revolves, the ink-jet head 1 moves in the X direction.

The Y-direction guide axis 5 is fixed to the base 9 so as not to move. The stage 7 is provided with a Y-direction drive motor 3. The Y-direction drive motor 3 is a stepping motor, for example, and moves the stage 7 in the Y direction upon receiving a drive signal for the Y direction from the control device CONT.

The control device CONT supplies voltage for controlling ink-jetting to the ink-jet head 1. Further, the control device CONT supplies a drive pulse signal to the X-direction drive motor 2 for controlling the X-direction movement of the ink-jet head 1 and supplies a drive pulse signal to the Y-direction drive motor 3 for controlling the Y-direction movement of the stage 7.

The cleaning unit 8 is for cleaning the ink-jet head 1. The cleaning unit 8 is provided with a drive motor for driving in the Y direction (not shown). By driving the drive motor in the Y direction, the cleaning unit moves along the Y-direction guide axis 5. Movement of the cleaning unit 8 is also controlled by the control device CONT.

The heater 15 here is a means to conduct heat treatment to the substrate P by lamp annealing, and it evaporates and dries the solvent contained in the liquid material coated on the substrate P. Supply and stopping supply of the voltage to this heater P are also controlled by the control device CONT.

The ink-jet device IJ ejects ink to the substrate P while scanning the ink-jet head 1 relative to the stage 7 that supports the substrate P. Note that, in the following description, the X direction is the scanning direction, and the Y direction is the non-scanning direction. Accordingly, the jet nozzles of the ink-jet head 1 are evenly spaced and lined in the Y direction which is the non-scanning direction.

FIG. 5 is a diagram to explain the principal of the liquid material ejection using a piezo ink-jet method.

In FIG. 5, a piezo element 22 is placed next to a liquid chamber 21 that holds the liquid material. The liquid chamber 21 receives the liquid material via a liquid material supply system 23 which has a material tank holding the liquid material. The piezo element 22 is coupled with a drive circuit 24, through which voltage is applied to the piezo element 22 so as to distort the piezo element 22. The liquid chamber 21 is thereby distorted, ejecting the liquid material from a nozzle 25. In this case, a volume of distortion of the piezo element 22 can be controlled by changing the amount of the voltage to be applied. Further, the speed of distortion of the piezo element can be controlled by changing frequency of the voltage to be applied.

Additionally, as an ink-jet method, a bubble (thermal) method may be employed, in which the liquid material is ejected in a form of foam (bubbles) generated when the liquid material is heated. However, the piezo method has an advantage that it does not readily affect the composition of the material because no heat is applied to the liquid material.

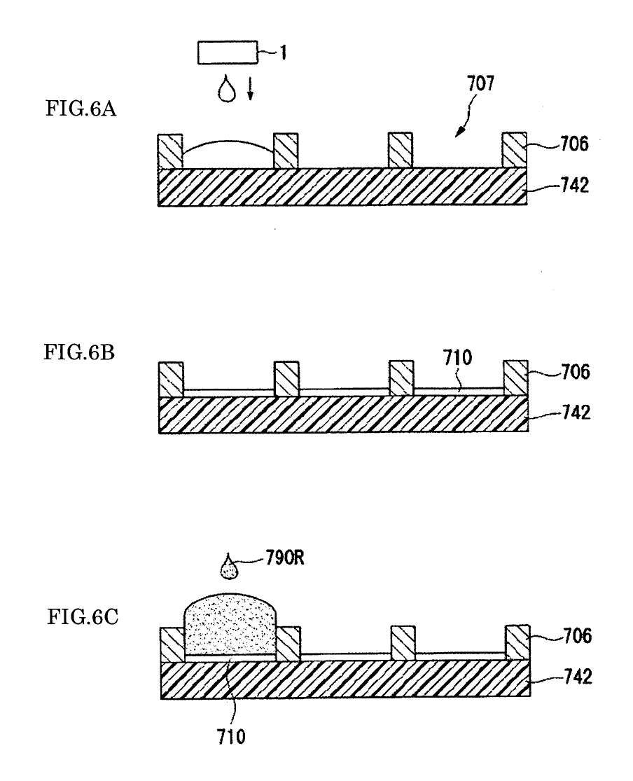

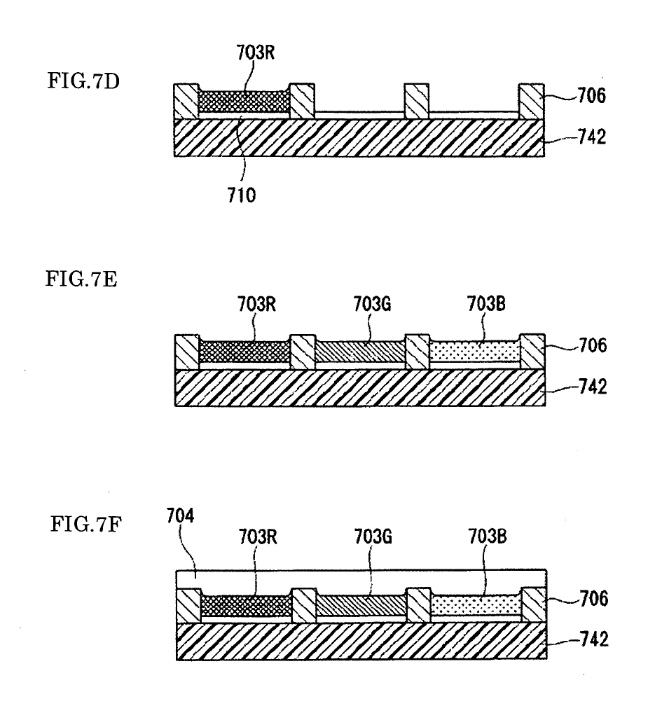

Next, procedures for manufacturing the color filter 751 using the ink-jet device IJ will be described. FIGS. 6 and 7 are diagrams showing an example of the method for manufacturing the color filter 751.

### FIRST EMBODIMENT

First, as shown in FIG. 6A, the partition wall 706 (black matrix) is formed against one surface of the transparent substrate 742. When forming this partition wall 706, a resin that does not transmit light (preferably, black-colored resin) is coated to have a given thickness (e.g., about 2 μm) by a method such as spin coating and is then patterned using a photolithography technique. Alternatively, an ink-jet process may be used

Further, when using the lithography method, an organic material is coated in accordance with the height of the partition wall by a given method such as spin coating, spray coating, roll coating, dye coating, dip coating, bar coating, or slit coating, and then a resist layer is coated thereon. Thereafter, in accordance with the configuration of the partition wall, masking is conducted so that the resist is exposed and developed and that the resist in accordance with the configuration of the partition wall remains. Finally, the partition wall material is removed from the area except for the masked area by etching. Also, the partition wall may be formed to have more than two layers, the lower layer being composed of inorganic material and the upper layer being composed of organic material.

Then, an aqueous dispersion of titanium oxide, in which fine particles of lyophilic titanium oxide (lyophilic liquid: ST-K21 of Ishihara Sangyo Kaisha, Ltd.) are dispersed in alcohol, is ejected from the ink-jet head 1 and lands inside the filter element formation region 707.

It is preferable that the fine particle of the titanium oxide has an average diameter of 1-500 nm, more preferably, 5-100 nm. Further, examples of the dispersing medium may be alcohols such as methanol, ethanol, i-propanol, n-propanol, n-butanol, i-butanol, t-butanol, methoxyethanol, ethoxyethanol, and ethylene glycol, or, alternatively, a combination of two or more thereof may also be used.

Now, because the partition wall 706 has liquid repellence, the aqueous dispersion of titanium oxide ejected to the filter element formation region 707 is repelled by the partition wall 706 even when it lands on the surface of the partition wall 706 and is introduced into the filter element formation region 707. Further, because alcohol is the dispersion agent of this aqueous dispersion, immediately after being introduced into the filter element formation region 707, the aqueous dispersion evaporates and dries to be formed into a transparent layer as shown in FIG. 6(B). Thus, the lyophilic layer 710 is formed in all of the plurality of filter element formation regions 707.

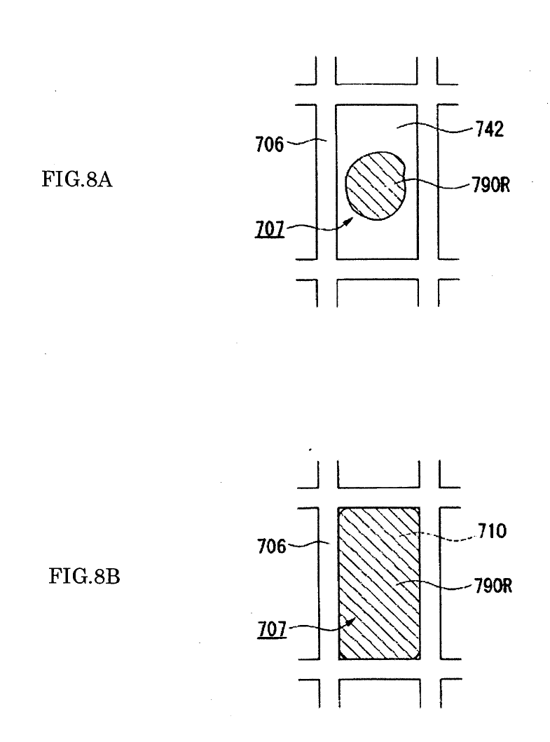

Next, as shown in FIG. 6(C), the ink R 790R (in liquid) is ejected and lands on the lyophilic layer 710 on the substrate 742. Here, if the ink 790R lands on the substrate 742 while the lyophilic liquid layer is not formed at the filter element formation region 707, the contact angle of the ink 790R to the substrate 742 is around 30°, and, therefore, the ink 790R does not diffuse sufficiently as shown in FIG. 8(A). However, if the ink 790R lands on the lyophilic layer 710 as in the present embodiment, the contact angle of the ink 790R is 5° or less to the lyophilic layer 710, and, therefore, the ink 790R diffuses over almost the entire surface of the filter element formation region 707, as shown in FIG. 8(B), provided that a given amount or more of the ink is ejected.

Additionally, the amount of the ink 790R ejected into the filter element formation region 707 should be sufficient, since the volume of the ink reduces during the heating operation.

Next, the liquid is pre-baked to make the R-color layer 703R as shown in FIG. 7(D). Thus described procedures are repeated for each color R, G, and B to successively form the color layers 703R, 703G, and 703B as shown in FIG. 7(E). After forming the color layers 703R, 703G, and 703B, they are baked altogether.

Next, as shown in FIG. 7(F), an overcoat layer (protection layer) 704 is formed to coat each color layer 703R, 703G, and 703B as well as the partition wall 706 in order to smooth out the substrate 742 and to protect the color layers 703R, 703G, and 703B. In order to form this protection layer 704, a method such as spin coating, roll coating, and lipping may be employed; however, as in the case with the color layers 703R, 703G, and 703B, the ink-jet process may be used.

In this embodiment, as described, because the coloring ink is ejected towards the filter element formation region 707 having the lyophilic layer 710 formed thereon, it is possible to diffuse the coloring ink inside the filter element formation region 707 and to obtain a uniform, flat, and evenly thick color layer even when the substrate 742 is not lyophilized.

Further, in this embodiment, because the aqueous dispersion of titanium oxide is coated by the ink-jet method, the amount of ink consumption is minimized compared to when the coating is done to the entire surface of the substrate. Thus, the lyophilic liquid can be used efficiently, and it is possible to form the lyophilic layer 710 and the color layers 703R, 703G, and 703B using the same device and procedures, which also helps to enhance productivity.

Moreover, in this embodiment, because the lyophilic layer 710 is formed using the lyophilic titanium oxide, it is not necessary to add the lyophilization process such as plasma treatment, and, therefore, the productivity can increase even further. In addition, in this embodiment, because the partition wall 706 is formed using the liquid repellent material, it is not necessary to conduct the plasma treatment to make the partition wall 706 be liquid repellent, which can contribute to higher productivity as well as to protection of the world environment.

Furthermore, in this embodiment, because the lyophilic layers 710 are formed after formation of the partition walls 706 on the substrate 742, the lyophilic layers 710 are separated; therefore, it is possible to prevent in advance the problem of color mixing caused by the color materials exuding into other filter element formation regions 707 through the lyophilic liquid layers.

Additionally, the liquid-crystal device according to the invention can be applied not only to the transmissive panel but also to a reflective panel and a semitransmissive reflective panel.

### SECOND EMBODIMENT

Next, a second embodiment of the method for manufacturing the color filter of the invention will be described.

The first embodiment showed the case in which the color layers were formed after forming the lyophilic liquid layers 710 in all the plurality of filter element formation regions 707; while, the present embodiment will show a case in which the coloring ink is coated on the filter element formation region 707 each time the lyophilic liquid droplet is ejected to each filter element formation region 707.

In this embodiment, an aqueous dispersion of silica, in which fine particles of lyophilic silica (ST-K211 of Ishihara Sangyo Kaisha, Ltd.) are dispersed in alcohol, is ejected as the lyophilic liquid from the ink-jet head 1 to land inside the filter element formation region 707.

It is preferable that the fine particle of the silica has an average diameter of 1-500 nm, more preferably, 5-100 nm. Further, examples of the dispersing medium may be alcohols such as methanol, ethanol, i-propanol, n-butanol, i-butanol, t-butanol, methoxyethanol, ethoxyethanol, and ethylene glycol, or, alternatively, a combination of two or more thereof may also be used.

In this case, the ink-jet head 1 shown in FIG. 4 has a composition in which the aqueous dispersion of silica is filled into a head part 21A placed at the front side of the relative movement direction (+Y side) during the ink ejection operation, and in which the color layer formation material is filled into a head part 21B at the rear side of the relative movement direction (−Y side), whereby this head ejects the ink containing the color layer formation material.

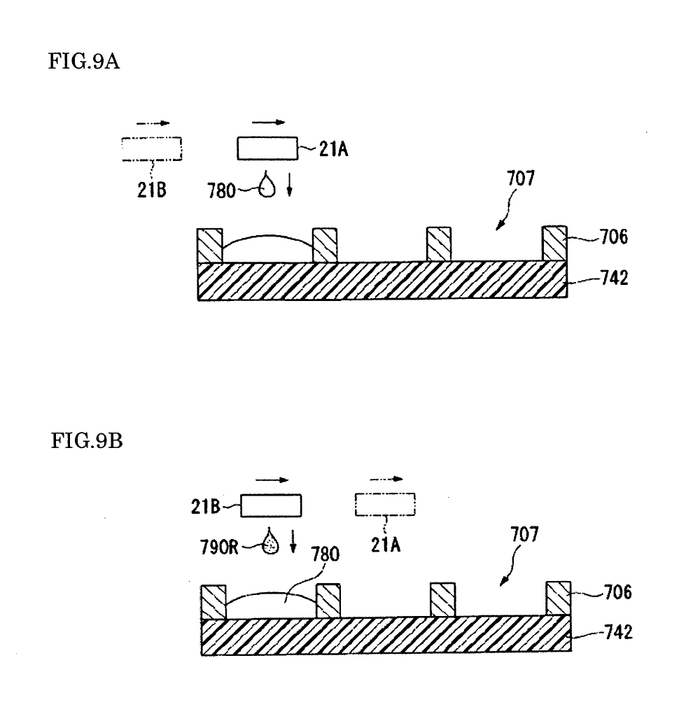

According to this composition, as shown in FIG. 9(A), the ink-jetting head parts 21A and 21B move relative to the substrate 742, and the ink-jetting head part 21A ejects an aqueous dispersion of silica 780 to the filter element formation region 707. Then, as shown in FIG. 9(B), following the head part 21A, the head part 21B moves to a position opposing the filter element formation region 707 and ejects the ink 790R containing the color layer formation material.

At this time, because the aqueous dispersion of silica and the ink containing the color layer formation material are ejected having a slight time lag, the color layer formation material lands before the dispersion medium of the aqueous dispersion of silica evaporates.

Therefore, the color layer formation material diffuses in the filter element formation region 707 together with the aqueous dispersion of silica, and, thereby, a layer is formed in the filter element formation region 707 upon evaporation of the dispersion medium.

Thus, the color layer is formed in all the filter element formation regions 707 when the ink containing the color layer formation material is ejected to coat the filter element formation region 707 every time the aqueous dispersion of silica is ejected.

In the embodiment, similar effects as those of the first embodiment are exerted. Also, it is possible to improve throughput and productive efficiency since the aqueous dispersion of silica and the ink containing the color layer formation material can be ejected in succession.

Now, the second embodiment has shown procedures in which the ink containing the color layer formation material is ejected before the dispersion medium in the aqueous dispersion of silica evaporates. However, if, in case, it is desirable to eject the ink containing the color layer formation material after the dispersion medium in the aqueous dispersion of silica evaporates due to the characteristics of the coloring material, it only needs to adjust the moving speed of the ink-jetting head part 21A relative to the moving speed of the ink-jetting head part 21B or to adjust the distance between these head parts 21A and 21B in the Y direction so that the head part 21B reaches the position opposite the filter element formation region 707 after the dispersion medium evaporates.

(Electronic Apparatus)

Next, an electronic apparatus having the color filter of the above-described embodiments will be described.

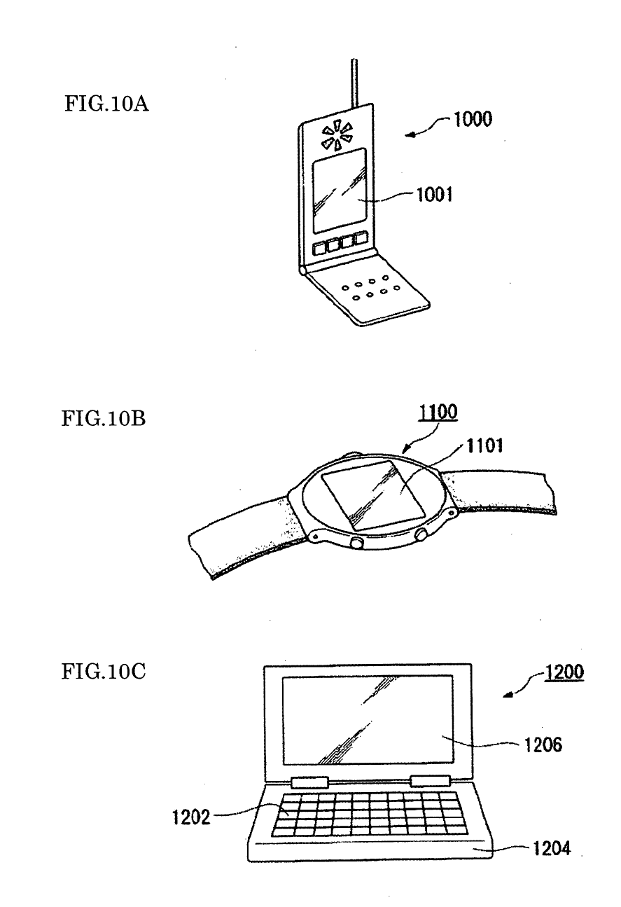

FIGS. 10(A)-10(C) show a working example of the electronic apparatus of the invention.

The electronic apparatus of this example is provided with the liquid-crystal device having the color filter of the invention as the display means.

FIG. 10(A) is a perspective view of an example of a cellular phone. In FIG. 10(A), a reference number 1000 is the cellular phone itself (electronic apparatus), and a reference number 1001 is the display unit using the liquid-crystal device.

FIG. 10(B) is a perspective view of an example of a wristwatch-type electronic apparatus. In FIG. 10(B), a reference number 1100 is the wristwatch itself (electronic apparatus), and a reference number 1101 is the display unit using the liquid-crystal device.

FIG. 10(C) is a perspective view of an example of a portable data processing device such as a word processor or a desktop/laptop computer. In FIG. 10(C), a reference number 1200 is the data processing device (electronic apparatus); a reference number 1202 is an input unit such as a keyboard; a reference number 1204 is the data processing device itself; and a reference number 1206 is the display unit using the liquid-crystal device.

Since the electronic apparatuses shown in FIGS. 10(A)-10(C) include the liquid-crystal device of the invention as the display means, high-precision and minute patterning is possible, and, thereby, electronic apparatuses having high-quality display characteristics can be obtained.

Although the preferred embodiments of the invention were hereinbefore described with reference to the accompanying drawings, the present invention is not at all limited to these examples. The configurations and combinations of the composition elements shown in the examples are only illustrative and can be modified in various ways based on designing requirements within the gist of the invention.

For example, although the embodiments show the configuration in which the partition wall 706 is composed of the liquid repellent material, the configuration is not limited thereto. The configuration may be such that a plasma treatment method (CF₄ plasma treatment method), which uses tetrafluoromethane as the gas for the treatment in the atmosphere, is employed, using an organic material which can become liquid repellent by the plasma treatment, which can adhere well to the underlying substrate, and which can be patterned easily by photolithography, such as an organic high-polymer material such as acrylic resin, polyimide resin, polyamide resin, polyester resin, olefin resin, and melamine resin or an inorganic high-polymer material such as polysilane, polisilazane, and polysiloxane.

Further, although the embodiments show the configuration in which the lyophilic layer 710 is formed using the lyophilic titanium oxide, other configurations are possible. The configuration may be such that realizes a greater lyophilic characteristic by irradiating the substrate 742 with ultraviolet; that is, by irradiating the material such as titanium oxide that acts as a photocatalyst with light having high-energy wavelength such as ultraviolet, the surface becomes polarized by conduction electrons and electron holes generated by the excitation light, and as water in a form of hydroxyl radicals is chemically absorbed into the surface, the surface turns superhydrophilic when a physically absorbed aqueous layer is further formed thereon.

Furthermore, because titanium oxide and the like has photocatalystic functions, the color layers 703R, 703G, and 703B may be negatively affected when exposed to ultraviolet. Therefore, it is preferable to provide the substrate 742 with an ultraviolet filter so as to block the ultraviolet rays from irradiating the lyophilic layer 710. In this case, the ultraviolet filter may be provided outside the polarizing film 716a shown in FIG. 2, for example, or be sandwiched between the retardation film 715a and the substrate 742.

In contrast, in the embodiments, although the active matrix liquid-crystal device was described as an example, a passive matrix liquid-crystal device can also be employed.

Further, although the drawings illustrate the example of the formation layout of the filter element formation regions 707 as striped-type, it may be mosaic-type, delta-type, square-type, and the like.

Moreover, although RGB are employed for the coloration of the filter element formation regions 707, in the embodiments, it can be YMC, where Y is yellow; M is magenta; and C is cyan.

What is claimed is:

1. A method for manufacturing a color filter, the color filter having a plurality of pixels surrounded by partition walls on a substrate, comprising:
forming the partition wall having a liquid repellence on the substrate;
forming a lyophilic layer by ejecting a lyophilic liquid droplet which develops a lyophilic characteristic in the pixel; and
coating a coloring droplet over the pixel on which the lyophilic layer has been formed.

2. The method for manufacturing the color filter according to claim 1, wherein the coloring droplet is coated after the lyophilic liquid droplet is ejected onto the plurality of pixels.

3. The method for manufacturing the color filter according to claim 1, wherein the coloring droplet is coated on the pixel every time the lyophilic liquid droplet is ejected onto each pixel.

4. The method for manufacturing the color filter according to claim 1, wherein the lyophilic liquid contains a fine particle composed of at least one substance selected from silica, titanium oxide, zinc oxide, tin oxide, strontium titanate, tungsten oxide, bismuth oxide, and ion oxide.

5. The method for manufacturing the color filter according to claim 4, wherein an average diameter of the fine particle contained in the lyophilic liquid is 1.0 μm or less.

6. The method for manufacturing the color filter according to claim 4, wherein the method includes developing the lyophilic characteristic in the lyophilic layer by conducting a plasma treatment to the substrate.

7. The method for manufacturing the color filter according to claim 4, wherein the method includes providing an ultraviolet filter on the substrate.

8. A color filter manufactured by the method for manufacturing the color filter according to claim 1.

9. An electro-optical device having the color filter according to claim 8.

10. An electronic apparatus having the electro-optical device according to claim 9.
